(19) United States
(12) Patent Application Publication
(10) Pub. No.: US 2013/0189420 A1
(43) Pub. Date: Jul. 25, 2013

(54) Agent for Cooked Rice

(71) Applicant: Matsutani Chemical Industry Co., Ltd., Hyogo (JP)

(72) Inventors: Makoto Tachibe, Hyogo (JP); Yoshiaki Maeda, Hyogo (JP); Shozo Sugano, Hyogo (JP)

(73) Assignee: Matsutani Chemical Industry Co., Ltd., Hyogo (JP)

(21) Appl. No.: 13/774,331

(22) Filed: Feb. 22, 2013

Related U.S. Application Data
(62) Division of application No. 13/210,984, filed on Aug. 16, 2011.

(30) Foreign Application Priority Data
Aug. 23, 2010 (JP) 2010-186209
Jul. 1, 2011 (JP) 2011-147653

(51) Int. Cl. A23L 1/182

(52) U.S. Cl. CPC A23L 1/182
USPC 426/618

(57) ABSTRACT

It is to provide a method for producing cooked rice with improved loosening properties, anti-aging property, and/or water retentivity, comprising adding and mixing a quality improving agent which is a degradation product of substituted modified starch with a viscosity of 15 mPa·s or higher at 30% by mass in an aqueous solution and 3000 mPa·s or lower at 10% by mass in an aqueous solution, wherein the degradation product of substituted modified starch is obtained by using, as a base material, one or more substituted modified starches selected from the group consisting of hydroxypropyl starch, hydroxypropylated distarch phosphate, and starch sodium octenylsuccinate, and is prepared by subjecting substituted modified starch to hydrolysis treatment with an enzyme in the process of rice cooking for preparing cooked rice.

This application is a divisional of application Ser. No. 13/210,984 filed Aug. 16, 2011, which claims priority to Japanese Application No. 2011-147653, filed Jul. 1, 2011, and to Japanese application No. 2010-186209, filed Aug. 23, 2010, the contents of each of which are incorporated in their entirety.

### TECHNICAL FIELD

The present invention relates to a non-oily, non-protein, and non-enzymatic improving agent for cooked rice. Particularly, the present invention relates to a quality improving agent for cooked rice which effectively imparts improving effect on loosening properties, anti-aging property, and/or water retentivity to cooked rice with as little influence as possible on the original texture and taste of the cooked rice, a method for producing cooked rice using the quality improving agent, and cooked rice with improved loosening properties, anti-aging property, and/or water retentivity using the method for producing cooked rice.

### BACKGROUND ART

For the production of cooked rice, batch production at factories has been increasingly seen with the growth of the food-service industry, progress in aseptic packaging technique, an increased number of frozen foods, etc. The large-scale production of cooked rice products often requires adding a starchy material or carbohydrate, an oil for rice cooking supplemented with an emulsifier, etc., an emulsified oil obtained by emulsifying oil and water with an emulsifier, or a protein preparation such as egg yolk, or the like, for improvement in machinability such as the facilitation of molding or measuring by making cooked rice easier to loose or the prevention of cooked rice from adhering to machines. Maltitol, sucrose, trehalose, dextrin, xanthan gum, guar gum, locust gum, Tara gum, pectin, water-soluble hemicellulose, or the like is used as the starchy material or carbohydrate. An emulsifier such as monoglycerin fatty acid ester, polyglycerin fatty acid ester, lecithin, or sucrose fatty acid ester is used in the oil for rice cooking supplemented with an emulsifier, etc. or the emulsified oil obtained by emulsifying oil and water with an emulsifier.

As examples for improving the loosening properties of cooked rice by adding, for example, a starchy material or carbohydrate, there are disclosed the addition of dextran (Japanese Unexamined Patent Publication No. 2005-328728), the addition of oligosaccharides such as trehalose, maltitol, and sucrose to soybean polysaccharides (Japanese Unexamined Patent Publication No. 2006-238758), the addition of an amylolytic enzyme and trehalose, pectin, and the like (Japanese Unexamined Patent Publication Nos. 2001-275589 and 2003-52319), the addition of indigestible dextrin and pectin (Japanese Unexamined Patent Publication No. 9-75022), and the addition of water-soluble hemicellulose (Japanese Unexamined Patent Publication No. 6-121647), etc.

Japanese Unexamined Patent Publication No. 2002-65184 discloses loosening improving agent for cooked rice, containing processed starch. This loosening improving agent for cooked rice, which is non-oily, is improved in that the addition of the loosening improving agent can avoid adverse effects (e.g., hardening of the texture of cooked rice or oily taste of cooked lice) brought about by the addition of oily-based loosening agents on the taste or texture of cooked rice. However, a remaining problem of this method is that a satisfactory level of loosening is still difficult to effectively obtain, though improvement to some extent is seen. Moreover, Japanese Unexamined Patent Publication No. 2007-228834 discloses a quality improving agent for starchy foods formulated with amylase and thickening polysaccharide or agar. However, this combination alone still presents problems such as hardening of the texture of cooked rice, a slimy touch, or the adverse effect by raw material taste on the taste of cooked rice. Thus, this method is not suitable for the current market that demands particularly delicious cooked rice.

In addition, as examples using emulsified oil comprising an oil supplemented with an emulsifier for improvement in the loosening properties of cooked rice, there are disclosed, for example, sodium stearoyl lactate or polyoxyethylene sorbitan fatty acid ester (Japanese Unexamined Patent Publication No. 2004-65216), organic acid monoglyceride such as diacetyltartaric acid, succinic acid, or citric acid (Japanese Unexamined Patent Publication No. 2004-49065), and propylene glycol fatty acid ester, triglycerin fatty acid ester, or tetraglycerin fatty acid ester (Japanese Unexamined Patent Publication No. 2009-82025) used as the emulsifier.

Furthermore, as examples using a protein preparation or the like for improvement in the loosening properties of cooked rice, there is disclosed an improving agent for the loosening properties of cooked rice, comprising phospholipase-treated egg yolk or whole egg dispersed in lipid (Japanese Unexamined Patent Publication Nos. 2004-41046 and 2005-295957), etc. In addition, there is disclosed degradation products of alginic acids used as an improving agent for the loosening properties of cooked rice (Japanese Unexamined Patent Publication No. 2006-296259).

On the other hand, a quality improving agent particularly used for the anti-aging property of cooked rice is disclosed as a quality improving agent for cooked rice. For example, Japanese Unexamined Patent Publication No. 9-215476 discloses a quality improving agent which inhibits the aging of starch in cooked rice, the quality improving agent comprising citrate and sugar alcohol. Japanese Unexamined Patent Publication No. 2001-17099 discloses a quality improving agent for cooked rice intended for anti-aging property during low-temperature storage, the quality improving agent consisting of brewed vinegar, saccharides such as sugar, and a thickener such as guar gum, xanthan gum, gum arabic, pullulan, or tamarind gum. These quality improving agents inevitably influence the taste of cooked rice, even if the effect of anti-aging property is obtained. Thus, they are not suitable, depending on use of cooked rice.

In addition, methods are also known which comprise adding various hydrolases for the purpose of obtaining anti-aging property and to modify the properties of cooked rice. For example, Japanese Unexamined Patent Publication No. 7-31396 discloses a quality improving agent for cooked rice, comprising modified starch formulated to a combination of amylase as an amylolytic enzyme and papain as a proteolytic enzyme for the purpose of the anti-aging property of cooked rice. Japanese Unexamined Patent Publication No. 2007-228834 discloses a quality improving agent for cooked rice or the like formulated with amylase and thickening polysaccharide or agar. Japanese Unexamined Patent Publication No. 10-234320 discloses a quality improving agent for cooked rice intended to prevent the deterioration or aging of cooked rice, the quality improving agent containing trehalose and amylase. However, the addition of enzyme preparations in the process of producing cooked rice requires controlling the quality of final products by controlling the temperature and pH during rice cooking, the quality of the enzyme itself, enzyme preparation measuring, etc. Thus, this approach should be avoided, if possible.

These conventional techniques relate to cooked rice improving agents for general aseptically packaged cooked rice that is produced by aseptically enclosing cooked rice after rice cooking. Also, cooked rice improving agents for cooked rice heat-sterilized under pressure (so-called retort cooked rice), which is produced by aseptic packaging also serving as rice cooking, have been studied. Such retort cooked rice is produced by subjecting raw rice and water to retort treatment. The cooked rice thus produced is in a rice cake-like plate form, which is hardly loosened and totally different from usual cooked rice.

As techniques for improving such loosening properties, there are disclosed, for example, a method for producing retort cooked rice having the uniform texture of grains by setting a heating time in a retort treatment step to over a usual one (30 minutes or longer) (Japanese Patent Unexamined Patent Publication No. 2006-158233) and a method which comprises partially gelatinizing raw material rice, cooling it, and then retort-sterilizing the cooled rice (Japanese Unexamined Patent Publication No. 6-303926). However, all of these methods have complicated steps, and existing facilities may not be applied directly thereto. Moreover, there are also disclosed a method for producing retort cooked rice, comprising mixing yacon (Smallanthus sonchifolius) or Helianthus tuberoses tuberous root portions and extracts (Japanese Unexamined Patent Publication No. 2006-67824), a method for producing stabilized retort cooked rice, comprising adding mannan and substantially removing free water by retort heating to prevent the run-off of the contents of rice grains (Japanese Unexamined Patent Publication No. 9-84535), etc. However, these methods inevitably have adverse effect on the taste and texture of cooked rice.

As described above, there have heretofore been disclosed many various quality improving agents intended for improvement in the loosening properties of cooked rice or the anti-aging property of cooked rice. However, cooked rice is composed mainly of carbohydrate and water and characterized in that because of its plain taste, the cooked rice keeps eaters from getting tired of eating it and can be eaten everyday. On the other hand, gustatory sense for cooked rice or its texture is delicate. The plain taste of cooked rice may be impaired by the addition of proteins, oil and fat, emulsifiers, etc. capable of imparting effective improving effect for loosening properties or anti-aging property as improving agents for loosening properties or anti-aging property. Moreover, on the other hand, when the influence on gustatory sense for cooked rice or its taste is minimized, effective improving effect cannot be obtained. Thus, it has been demanded to develop a quality improving agent for cooked rice that can achieve both the characteristics of cooked rice and improving effect.

### PRIOR ART DOCUMENTS

### Patent Documents

Patent Document 1: Japanese Unexamined Patent Publication No. 6-121647
Patent Document 2: Japanese Unexamined Patent Publication No. 6-303926
Patent Document 3: Japanese Unexamined Patent Publication No. 7-31396
Patent Document 4: Japanese Unexamined Patent Publication No. 9-75022
Patent Document 5: Japanese Unexamined Patent Publication No. 9-84535
Patent Document 6: Japanese Unexamined Patent Publication No. 9-215476
Patent Document 7: Japanese Unexamined Patent Publication No. 10-234320
Patent Document 8: Japanese Unexamined Patent Publication No. 2001-17099
Patent Document 9: Japanese Unexamined Patent Publication No. 2001-275589
Patent Document 10: Japanese Unexamined Patent Publication No. 2002-65184
Patent Document 11: Japanese Unexamined Patent Publication No. 2003-52319
Patent Document 12: Japanese Unexamined Patent Publication No. 2004-41046
Patent Document 13: Japanese Unexamined Patent Publication No. 2004-49065
Patent Document 14: Japanese Unexamined Patent Publication No. 2004-65216
Patent Document 15: Japanese Unexamined Patent Publication No. 2005-295957
Patent Document 16: Japanese Unexamined Patent Publication No. 2005-328728
Patent Document 17: Japanese Unexamined Patent Publication No. 2006-67824
Patent Document 18: Japanese Unexamined Patent Publication No. 2006-158233
Patent Document 19: Japanese Unexamined Patent Publication No. 2006-238758
Patent Document 20: Japanese Unexamined Patent Publication No. 2006-296259
Patent Document 21: Japanese Unexamined Patent Publication No. 2007-228834
Patent Document 22: Japanese Unexamined Patent Publication No. 2009-82025
Patent Document 23: Japanese Unexamined Patent Publication No. 2005-295957

### SUMMARY OF THE INVENTION

### Problem to be Solved by the Invention

An object of the present invention is to provide a quality improving agent for cooked rice which effectively imparts improving effect on loosening properties, anti-aging property, and/or water retentivity to cooked rice with as little influence as possible on the original texture and taste of the cooked rice, a method for producing cooked rice using the quality improving agent, and cooked rice with improved loosening properties, anti-aging property, and/or water retentivity using the method for producing cooked rice, and is particularly to provide a method for producing cooked rice having excellent texture and taste, wherein improving effect on loosening properties, anti-aging property, and/or water retentivity is effectively imparted to cooked rice using a non-oily, non-protein, and non-enzymatic quality improving agent for cooked rice, while the resulting cooked rice retains its original texture and taste.

### Means to Solve the Object

To attain the object, the present inventor has conducted diligent search for a quality improving agent for cooked rice which effectively imparts improving effect on loosening properties, anti-aging property, and/or water retentivity to cooked rice with as little influence as possible on the original texture and taste of the cooked rice for the purpose of developing a non-oily, non-protein, and non-enzymatic quality improving agent for cooked rice. Consequently, the present inventor has completed the present invention by finding that a degradation product of substituted modified starch whose viscosity has been adjusted to a particular viscosity range by hydrolysis treatment with an acid, molecular weight reduction treatment with an oxidizing agent, or hydrolysis treatment with an enzyme, or the like can be used as the quality improving agent for cooked rice, and as a result, improving effect on loosening properties, anti-aging property, and/or water retentivity is effectively imparted to cooked rice, while cooked rice that retains the original texture and taste of cooked rice and has excellent texture and taste can be produced.

The present invention provides a quality improving agent for cooked rice which imparts improving effect on loosening properties, anti-aging property, and/or water retentivity to cooked rice, the quality improving agent containing a degradation product of substituted modified starch whose viscosity is 15 mPa·s or higher at 30% by mass in an aqueous solution and 3000 mPa·s or lower at 10% by mass in an aqueous solution.

Specifically, the present inventor has conducted diligent search to develop a cooked rice improving agent that improves machinability during production, suppresses unfavorable aging-derived smell generated during the storage of cooked rice, and maintains the moisture content of cooked rice without the use of non-carbohydrate materials such as oil and fat, proteins, and emulsifiers, which influence the quality (e.g., taste and texture) of cooked rice and also without the use of enzyme preparations that may become imponderables in a rice cooking step. Consequently, the present inventor has found that a quality improving agent for cooked rice that can satisfy the requirements can be provided by using, as a quality improving agent for cooked rice, substituted modified starch whose viscosity has been adjusted to a particular viscosity range by the hydrolysis or molecular weight reduction of the substituted modified starch. Specifically, the present inventors have found that, surprisingly, machinability typified by loosening is much more improved by rice cooking after addition of substituted modified starch whose viscosity has been adjusted to a particular viscosity range by the hydrolysis or molecular weight reduction of the substituted modified starch, than addition of untreated modified starch. At the same time, aging-derived smell specific for cooked rice was suppressed, and the moisture content of cooked rice was maintained. In addition, it has been found that cooked rice having excellent taste and texture can be provided with little influence on the original gustatory sense for cooked rice. It has further been found that the effect of the cooked rice improving agent is further enhanced by adding a thickener to the degradation product of modified starch.

In the present invention, examples of the degradation product of substituted modified starch used as a quality improving agent for cooked rice can include degradation products obtained using, as a base material, one or more substituted modified starches selected from the group consisting of hydroxypropyl starch, hydroxypropylated distarch phosphate, and starch sodium octenylsuccinate. The degradation product of substituted modified starch can be prepared by subjecting substituted modified starch to hydrolysis treatment with an acid, molecular weight reduction treatment with an oxidizing agent, or hydrolysis treatment with an enzyme.

In addition, the present invention can provide a quality improving agent for cooked rice, containing a thickener in addition to the degradation product of substituted modified starch. Preferable examples of such a thickener include one or more thickening polysaccharides selected from xanthan gum, guar gum, ghatti gum, and carrageenan. In such a case, the ratio between the degradation product of substituted modified starch and the thickener ranges preferably 1:1 to 100,000:1.

In one aspect, the present invention encompasses a method for producing cooked rice improved in loosening properties, anti-aging property, and/or water retentivity, comprising adding and mixing the quality improving agent for cooked rice of the present invention in the process of rice cooking for preparing cooked rice. In such a case, the quality improvement of cooked rice can be achieved by mixing the quality improving agent for cooked rice of the present invention with raw rice in an amount of 0.1 to 10% by weight with respect to raw rice followed by cooking, in the process of rice cooking for preparing cooked rice. Moreover, the quality improvement of cooked rice can be achieved by mixing the quality improving agent for cooked rice of the present invention with cooked rice in an amount of 0.1 to 10% by weight with respect to white cooked rice, in the process of rice cooking for preparing cooked rice. In the present invention, examples of the cooked rice include white rice, salted rice, and sushi rice (rice seasoned with vinegar, sugar and salt, used for preparing sushi).

In one aspect, the present invention encompasses cooked rice with improved loosening properties, anti-aging property, and/or water retentivity, which is produced by the method for producing cooked rice according to the present invention. Examples of the cooked rice include retort cooked rice produced by subjecting raw rice and water to retort treatment.

Specifically, the present invention provides: [1] a quality improving agent for cooked rice which imparts improving effect on loosening properties, anti-aging property, and/or water retentivity to cooked rice, the quality improving agent comprising a degradation product of substituted modified starch with a viscosity of 15 mPa·s or higher at 30% by mass in an aqueous solution and 3000 mPa·s or lower at 10% by mass in an aqueous solution; [2] the quality improving agent for cooked rice according to [1], wherein the degradation product of substituted modified starch is a degradation product obtained by using, as a base material, one or more substituted modified starches selected from the group consisting of hydroxypropyl starch, hydroxypropylated distarch phosphate, and starch sodium octenylsuccinate; [3] the quality improving agent for cooked rice according to [1] or [2], wherein the degradation product of substituted modified starch is prepared by subjecting substituted modified starch to hydrolysis treatment with an acid, molecular weight reduction treatment with an oxidizing agent, or hydrolysis treatment with an enzyme; and [4] the quality improving agent for cooked rice according to any one of [1] to [3], comprising a thickener in addition to the degradation product of substituted modified starch.

Specifically, the present invention also provides: [5] the quality improving agent for cooked rice according to [4], wherein the thickener is one or more thickening polysaccharides selected from xanthan gum, guar gum, ghatti gum, and carrageenan; [6] the quality improving agent for cooked rice according to [4] or [5], wherein a ratio between the degradation product of substituted modified starch and the thickener ranges 1:1 to 100000:1; [7] method for producing cooked rice with improved loosening properties, anti-aging property, and/or water retentivity, comprising adding and mixing a quality improving agent for cooked rice according to any one of [1] to [6] in the process of rice cooking for preparing cooked rice; and [8] the method for producing cooked rice according to [7], wherein the quality improving agent for cooked rice is mixed with raw rice in an amount of 0.1 to 10% by weight with respect to raw rice and cooked in the process of rice cooking for preparing cooked rice.

The present invention further provides: [9] the method for producing cooked rice according to [7], wherein the quality improving agent for cooked rice is mixed with white cooked rice in an amount of 0.1 to 10% by weight with respect to white cooked rice in the process of rice cooking for preparing cooked rice; [10] the method for producing cooked rice according to any one of [7] to [9], wherein the cooked rice is white rice, salted rice, or sushi rice; [11] cooked rice with improved loosening properties, anti-aging property, and/or water retentivity, produced by a method for producing cooked rice according to any one of [7] to [10]; and [12] the cooked rice according to [11], wherein the cooked rice is retort-sterilized.

### Effect of the Invention

The present invention can provide a quality improving agent for cooked rice which effectively imparts improving effect on loosening properties, anti-aging property, and/or water retentivity to cooked rice with as little influence as possible on the original texture and taste of the cooked rice, a method for producing cooked rice using the quality improving agent, and cooked rice with improved loosening properties, anti-aging property, and/or water retentivity using the method for producing cooked rice.

The cooked rice improving agent of the present invention adds a carbohydrate-based material to cooked rice and can thus minimize the influence on its taste. On the other hand, the improving agent of the present invention can effectively impart improving effect on loosening properties, etc., which are the problems of conventional non-oily, non-protein, and non-enzymatic quality improving agents for cooked rice, and can drastically improve workability during the large-scale production of cooked rice. In addition, the effect of improving loosening properties also contributes to the appropriate loosening of rice balls or sushi rice balls. Moreover, the cooked rice improving agent of the present invention also has the effect of suppressing the aging-derived smell of cooked rice.

The cooked rice improving agent of the present invention can also be applied to the production of aseptically packaged cooked rice and retort cooked rice and particularly enables easy production of retort cooked rice by the direct heating of raw rice under pressure, which has heretofore been difficult to produce. The thus-obtained aseptically packaged cooked rice and retort cooked rice that can be stored for a long period can be eaten by reheating using a cooking range, warming in hot water, or the like and can be processed easily into chazuke, zosui, or the like by loosening the cooked rice by the addition of hot water, a seasoning liquid, soup, etc. Thus, the aseptically packaged cooked rice and retort cooked rice are also useful as emergency food. In addition, the processed starch used in the present invention is also known as resistant starch (indigestible starch). Thus, the use of the cooked rice improving agent of the present invention can also be expected to exert secondary effects such as beneficial physiological functions, for example, intestinal regulation effect, inhibitory effect on rise in blood sugar level, and reducing effect on cholesterol levels, low GI, and low calories.

### MODE OF CARRYING OUT THE INVENTION

The present invention provides a quality improving agent for cooked rice which imparts improving effect on loosening properties, anti-aging property, and/or water retentivity to cooked rice, the quality improving agent containing a degradation product of substituted modified starch whose viscosity is 15 mPa·s or higher at 30% by mass in an aqueous solution and 3000 mPa·s or lower at 10% by mass in an aqueous solution by subjecting substituted modified starch to hydrolysis treatment with an acid, molecular weight reduction treatment with an oxidizing agent, or hydrolysis treatment with an enzyme. In addition, the present invention provides a method for producing cooked rice using the quality improving agent, and cooked rice with improved loosening properties, anti-aging property, and/or water retentivity using the method for producing cooked rice.

(Quality Improvement of Cooked Rice)

The quality improvement of cooked rice of the present invention is achieved by adding a degradation product of substituted modified starch described later in the process of rice cooking for preparing cooked rice. The quality improving agent for cooked rice can be added at the time of or after rice cooking. The optimal amount of the quality improving agent added at the time of rice cooking is 0.1 to 10% with respect to raw rice. When the amount of the quality improving agent added is smaller than this range, no sufficient effect is obtained. When the amount of the quality improving agent added is larger than this range, the resulting cooked rice becomes too much loosened, impairing the value as cooked rice. In addition, the cooked rice improving agent may be mixed with cooked rice after cooking. For example, for preparing sushi rice, the cooked rice improving agent can be used by mixing in advance with sushi vinegar. In this case, the optimal amount of the improving agent added is 0.1 to 10% with respect to cooked rice. When the amount of the improving agent added is smaller than this range, no sufficient effect is obtained. When the amount of the improving agent added is larger than this range, the resulting cooked rice becomes too much loosened, impairing the value as cooked rice.

Moreover, the effect of improving the quality of cooked rice can be enhanced by using a thickener such as xanthan gum, guar gum, or carrageenan in combination with the degradation product of substituted modified starch. The amount of the thickener added can adopt a ratio of 1:1 to 100000:1 between the degradation product of substituted modified starch and the thickener. The effect of improving the quality of cooked rice can be exhibited by the addition of the thickener. Particularly, in the present invention, the effect is obtained even when the proportion of the thickening polysaccharide is exceedingly small. For using the quality improving agent for cooked rice of the present invention, oily-based, protein-based, and/or enzyme-based cooked rice improving agent(s) may be used in combination therewith so long as the effect of the quality improving agent for cooked rice of the present invention is not impaired. Specifically, various oils and fats, oily-based preparations, protein-based preparations, carbohydrate/sugar alcohol-based preparations, emulsifiers, pH adjusters, organic acid/organic acid salt-based preparations, inorganic acid/inorganic acid salt-based preparations, enzyme preparations, etc., can be used alone or in combination, together with the cooked rice improving agent of the present invention. Specific examples thereof include enzymatic degradation products of various proteins such as lactoalbumin, oligosaccharide, reduced oligosaccharide, citrate, degradation products of various carbohydrates, sorbitol, maltitol, transglutaminase, and polyphenol oxidase.

(Raw Material Starch)

A degradation product of substituted modified starch whose viscosity has been adjusted to a particular viscosity range by subjecting substituted modified starch to hydrolysis treatment with an acid, molecular weight reduction treatment with an oxidizing agent, or hydrolysis treatment with an enzyme is used for preparing the quality improving agent for cooked rice of the present invention. Natural starch found in the natural world, starch derived from plants obtained by standard breeding techniques including cross breeding, translocation, inversion, transformation, or various other genetic or chromosomal engineering approaches including modifications thereof, or starch obtained from plants that can be produced by artificial mutation and known standard mutation breeding methods can be used as a raw material starch for substituted modified starch that serves as a base material for the degradation product of substituted modified starch. Typical sources of the raw material starch are cereals, tubers, roots, legumes, and fruits. Specific examples of natural sources include corn, pea, potato, sweet potato, banana, barley, wheat, rice, sago, amaranth, tapioca, canna, sorghum, and waxy species or high-amylose varieties thereof. Particularly preferable examples of the raw material starch include tapioca starch and waxy starch.

(Degradation Product of Modified Starch)

The substituted modified starch used in the present invention may be any processed starch such as etherified starch and esterified starch, and examples thereof include hydroxypropylated starch, hydroxypropylated distarch phosphate, starch acetate, acetylated distarch phosphate, phosphated starch, phosphated distarch phosphate, and starch sodium octenylsuccinate. The substituted modified starch can preferably contain one or more of them. Particularly preferable examples of the base material for the degradation product of substituted modified starch include any substituted modified starch selected from hydroxypropylated starch, hydroxypropylated distarch phosphate, and starch sodium octenylsuccinate. Moreover, in the present invention, treatment such as processing acceptable as edible starch processing, for example, acid treatment, alkali treatment, bleaching treatment, enzymatic treatment, gelatinization treatment, roasting treatment, or wet heat treatment, may be used in combination therewith for the substituted modified starch.

A hydrolysis product of substituted modified starch used in the present invention refers to substituted modified starch whose viscosity has been reduced by some degradation method and is specifically exemplified by: pyrodextrin obtained by roasting substituted modified starch in a powder form together with a trace amount of an acid (e.g., hydrochloric acid and nitric acid); soluble starch obtained by adding an acid (e.g., sulfuric acid and hydrochloric acid) or an oxidizing agent (e.g., sodium hypochlorite) to a suspension of substituted modified starch and subjecting the modified starch in a particle form to molecular weight reduction; those obtained by the molecular weight reduction of unmodified starch gelatinized by the addition of an acid such as oxalic acid or hydrochloric acid and heating; enzymatic degradation products obtained by hydrolysis of the modified starch with α amylase, β amylase, or the like; and reduced forms thereof obtained by hydrogenation. The morphology thereof may be a liquid or a spray-dried or drum-dried powder. Moreover, the soluble starch may be starch that is rendered cold water-soluble by gelatinization using a drum dryer during drying. Furthermore, starch processed into a form that is rendered easily soluble by, for example, physical treatment such as granulation may be used for improving solubility.

(Viscosity of Degradation Product of Modified Starch)

In the present invention, a degradation product of modified starch whose viscosity falls within a range of 15 mPa·s or higher at 30% by mass in an aqueous solution and 3000 mPa·s or lower at 10% by mass in an aqueous solution is used. For reference purposes, commercially available dextrin having DE (dextrose equivalent: reducing power of a sample when that of glucose is defined as 100) of approximately 20 generally has a viscosity lower than 10 mPa·s at 30% by mass. General unmodified starch exhibits a viscosity as high as approximately several tens of thousands of mPa·s at 10% by mass. A degradation product of substituted modified starch whose viscosity goes out of this range cannot sufficiently exert the effect of the present invention. Specifically, when a degradation product of substituted modified starch whose viscosity is lower than 15 mPa·s at 30% by mass in an aqueous solution is used, loosening effect cannot be obtained. Moreover, when a degradation product of substituted modified starch whose viscosity exceeds 3000 mPa·s at 10% by mass in an aqueous solution is used, it contrarily tends to exhibit effect opposite to loosening effect due to increased binding strength.

(Measurement of Viscosity)

In the present invention, the viscosity at 30% by mass in an aqueous solution is indicated as a value that is determined by weighing 60 g (in terms of solid content) of the sample into a 200-ml beaker, adding water to bring the total amount to 200 g, directly dissolving the sample (when the sample is soluble in cold water) or cooling the sample after heating to 90° C. (when the sample is soluble in hot water) and correcting evaporative water loss, and then measuring the viscosity at 30° C. using a type-B rotational viscometer. In addition, the viscosity at 10% by mass in an aqueous solution is indicated as a value that is determined by weighing 20 g (in terms of solid content) of the sample into the beaker, adding water to bring the total amount to 200 g, and subsequently performing the same procedures as those for the measurement of the viscosity at 30% by mass in an aqueous solution.

(Thickener)

Examples of the thickener used in the cooked rice improving agent of the present invention is exemplified by thickening stabilizers, thickeners, gelling agents, agar, and thickening polysaccharide, which are added for the purpose of thickening or gelling general drinks or foods. Specific examples of the thickening polysaccharide include xanthan gum, pectin, guar gum, gum arabic, locust bean gum, Tara gum, tamarind gum, gellan gum, ghatti gum, psyllium seed gum, sodium alginate, carrageenan, arabinoxylan, arabinogalactan, karaya gum, pullulan, carboxymethylcellulose, curdlan, and glucomannan. These thickeners are used alone or in combination of two or more thereof. In the present invention, the large effect of improving cooked rice is obtained particularly when xanthan gum, guar gum, carrageenan, and/or ghatti gum are used.

(Cooked Rice)

In the present invention, rice used in the cooked rice is preferably non-waxy rice or may be steamed rice by partially or wholly substituting the non-waxy rice by waxy rice. In addition, various minor cereals used for the main purpose of enriching the nutrients of cooked rice, such as Echinochloa esculenta, Setaria italica, wheat, barley, sesame may be added appropriately thereto.

The cooked rice described in the present invention encompasses: unseasoned cooked white rice; salted rice having salty taste imparted using salt, Furikake (dried seasoning for sprinkling on rice), or the like; cooked white rice gruel obtained by adding water in an increased amount; various rice gruels supplemented with a pickled ume, salmon, egg, or the like; sushi rice supplemented with vinegar, sugar, mirin (sweet cooking rice wine), dashi (Japanese soup stock made from fish and kelp), or the like; Takikomi-gohan (rice dish cooked with other ingredients) or Maze-gohan (cooked rice mixed with other ingredients), pilaf, fried rice, risottos, Sekihan (rice boiled with red beans), various kinds of Okowa (steamed waxy rice) obtained by appropriately mixing, before or after rice cooking, various seasoning liquids such as dashi, soy sauce, sake, mirin, vinegar, and flavors, various seasoning powders such as salt, sugar, and pepper, and various ingredients such as beans (e.g., red beans or black eye beans), vegetables, mountain vegetables, fishery products, egg, meats, and processed meats; and cooked rice, chazuke, and zosui obtained by appropriately adding various seasoning liquids, various seasoning powders, and various ingredients described above to polished rice after rice cooking, followed by heat-cooking. The form of these dishes of cooked rice is exemplified by, but not limited to, school meals, packed lunches, aseptic packages, retort packages, and canned goods. These forms can also be mixed in advance or accompanied with various Furikake, an instant ingredient for chazuke, an instant ingredient for zosui, or the like.

In addition, various enrichments or commercially available cooked rice improving agents can also be used in combination with the improving agent of the present invention. For example, indigestible dextrin, polydextrose, or the like may be added before or after rice cooking for the purpose of fortifying food fiber. Moreover, the improving agent of the present invention may be used for konjac rice such as Mannan rice, artificial rice such as Starch rice, gelatinized rice, etc. The cooked rice thus obtained can be stored at room temperature, refrigerated, or frozen and can also be reheated for eating, if necessary, using a cooking range or the like. In the present invention, the optimal cooked rice is polished rice, salted rice, or sushi rice. Such cooked rice formulated with the improving agent of the present invention has favorable loosening properties and is thus particularly suitable as rice balls, sushi rice, or cooked rice for curry.

Next, the present invention will be described specifically with reference to Examples, Comparative Examples, and Test Examples. However, the present invention is not limited to these Examples. In Examples, Comparative Examples, and Test Examples below, the term “part” means a “part by mass”, unless otherwise specified.

### EXAMPLES

### Comparative Example 1

Slurry containing 20 parts of sodium sulfate and 100 parts of waxy corn starch added to 130 parts of water was prepared. 30 parts of a 3% aqueous caustic soda solution and 0.1 part of phosphorus oxychloride were added thereto with stirring and reacted at 40° C. for 1 hour. To the obtained sample, 10 parts of propylene oxide were added and reacted at 40° C. for 20 hours. Then, the reaction product was neutralized with hydrochloric acid, washed with water, dehydrated, and dried to obtain a comparative agent 1.

### Comparative Example 2

Slurry containing 20 parts of sodium sulfate and 100 parts of tapioca starch added to 130 parts of water was prepared. 30 parts of a 3% aqueous caustic soda solution and 10 parts of propylene oxide were added thereto with stirring and reacted at 40° C. for 20 hours. Then, the reaction product was neutralized with hydrochloric acid, washed with water, dehydrated, and dried to obtain a comparative agent 2.

### Examples 1-2

100 parts of a solid of the comparative agent 1 or 2 were suspended in 200 parts of water. 0.15 part of a amylase (product name: KLEISTASE KM) manufactured by Daiwa Fine Chemicals Co., Ltd. was allowed to act thereon with heating and stirring by a routine method to obtain cooked rice improving agents 1 and 2.

### Example 3

A starch emulsion containing 100 parts of waxy corn starch dispersed in 125 parts of water at 30° C. was prepared. A 3% sodium hydroxide solution was added thereto with stirring. 3 parts of octenyl succinic anhydride were added thereto with pH kept at 8 to 9 and reacted until the pH of the starch emulsion stayed unchanged. Then, the reaction product was neutralized with 5% by mass of a sulfuric acid solution, washed with water, and then dehydrated. The dehydrated cake was dispersed in water to prepare a starch emulsion having a Baume degree of 18. After confirmation that the pH of the starch emulsion was 6±0.2, 0.1% of α-amylase (KLEISTASE L1) manufactured by Daiwa Fine Chemicals Co., Ltd. was added with respect to the starch. The mixture was heated to 85° C. and then kept for 30 minutes to liquefy the starch. A 10% aqueous hydrochloric acid solution was added thereto to decrease the pH to 3.5 and inactivate the enzyme. The reaction product was neutralized with a 10% aqueous caustic soda solution, decolorized with active carbon, then spray-dried to obtain a cooked rice improving agent 3.

### Comparative Example 3

100 parts of a waxy corn starch solid were suspended in 200 parts of water. 0.15 part of α amylase (product name: KLEISTASE KM) manufactured by Daiwa Fine Chemicals Co., Ltd. was allowed to act thereon with heating and stirring by a routine method to obtain a comparative agent 3.

### Comparative Example 4

The pH of slurry containing 100 parts of tapioca starch and 130 parts of water was adjusted to 8.0 with a 3% caustic soda solution. 23 parts of sodium hypochlorite (13% in terms of available chlorine) were added thereto and reacted for 4 hours while keeping pH as adjusted. The reaction product was neutralized with hydrochloric acid, washed with water, dehydrated, and dried to obtain a comparative agent 4.

### Comparative Example 5

The pH of slurry containing 100 parts of potato starch and 130 parts of water was adjusted to 8.0 with a 3% caustic soda solution. 38 parts of sodium hypochlorite (13% in terms of available chlorine) were added thereto and reacted for 4 hours while keeping pH as adjusted. The reaction product was neutralized with hydrochloric acid, washed with water, dehydrated, and dried to obtain a comparative agent 5.

### Comparative Example 6

4.5 kg of waxy corn starch was weighed into a paddle dryer (manufactured by Nara Machinery Co., Ltd.; volume: 10 L). 160 g of a 1% aqueous hydrochloric acid solution was sprayed thereonto with stirring. The mixture was mixed by stirring for uniformity and then heated to 60° C. for preliminary drying to a water content of 7.5%. The heating temperature was set to 115° C., and heat treatment was performed for 25 minutes. To 100 parts of the obtained sample, 120 parts of water were added to prepare a suspension whose pH was then adjusted to 10 with a 3% aqueous caustic soda solution. 3 parts of sodium hypochlorite (13% in terms of available chlorine) were added thereto and treated for 1 hour while keeping pH as adjusted. Then, the reaction product was neutralized with hydrochloric acid, washed with water, dehydrated, and dried to obtain a comparative agent 6.

TABLE 1

| | | | Viscosity | Viscosity | | | | |
|---|---|---|---|---|---|---|---|---|
| | | | at 30% | at 10% | | | | |
| | | | (15 | (3000 | | | | |
| | Raw | | mPa · s | mPa · s | Evaluation on cooked rice | | | |
| | material | Processing | or | or | | | | General |
| | starch | method | higher) | lower) | Loosening | Stickiness | Hardness | evaluation |
| Cooked rice | Waxy corn | HP distarch | 165 | 4 | 8 | 4 | 7 | Good |
| improving | | + enzymatic | | | | | | |
| agent 1 | | degradation | | | | | | |
| Comparative | Waxy corn | HP distarch | — | 142,000 | 4 | 8 | 7 | Unnatural |
| agent 1 | | | | | | | | texture |
| Cooked rice | Tapioca | HP + | 255 | 5 | 6 | 4 | 8 | Good |
| improving | | enzymatic | | | | | | |
| agent 2 | | degradation | | | | | | |
| Comparative | Tapioca | HP | — | 42,000 | 2 | 6 | 5 | Unnatural |
| agent 2 | | | | | | | | texture |
| Cooked rice | Waxy corn | OS + Acid | 45 | 3 | 8 | 7 | 6 | Good |
| improving | | roasting | | | | | | |
| agent 3 | | | | | | | | |
| Comparative | Waxy Corn | Enzymatic | 640 | 14 | 4 | 8 | 8 | Unnatural |
| agent 3 | | degradation | | | | | | texture |
| Comparative | Tapioca | Bleaching | 200 | 7 | 4 | 7 | 7 | Unnatural |
| agent 4 | | | | | | | | texture |
| Comparative | Potato | Bleaching | 500 | 12 | 3 | 8 | 8 | Unnatural |
| agent 5 | | | | | | | | texture |
| Comparative | Waxy Corn | Bleaching | 134 | 4 | 4 | 7 | 7 | Close to |
| agent 6 | | | | | | | | control |
| | | | | | | | | example |
| Control | | | | | 3 | 6 | 6 | (Usual |
| example | | | | | | | | cooked |
| | | | | | | | | rice) |
| Reference | | | | | 8 | 2 | 6 | Brown |
| example | | | | | | | | appearance |

HP distarch: hydroxypropylated distarch phosphate
HP: hydroxypropyl starch
OS: starch sodium octenylsuccinate

### Example 4

Two 180-cc cups (300 g) of commercially available no-wash rice (KIRARA 397) were quickly washed and dipped in a sufficient amount of water at room temperature for 30 minutes. Water was removed from the obtained rice using a colander. 1.5 g of the cooked rice improving agent or comparative agent shown in Table 1 was added and mixed thereto. Water was added thereto to bring the total weight to 810 g, and automatic rice cooking was performed using a domestic electric rice cooker. The obtained cooked rice was taken out of the cooker and homogeneously stirred with the whole part loosened using a rice paddle. The rice was covered with plastic wrap to prevent water evaporation and then cooled to room temperature. Then, the cooked rice was evaluated. Unsupplemented cooked rice was set as a control example, while cooked rice supplemented with 1.5 g of a commercially available cooked rice improving agent soybean food fiber (SM700) manufactured by San-Ei Gen F.F.I., Inc. instead of the cooked rice improving agent of the present invention was also evaluated as a reference example. The evaluation was conducted on a 1-10 scale by sensory testing for loosening, stickiness, and hardness. The larger numeric values in the evaluation represent more favorably loosened, more strongly sticky, and harder cooked rice.

Table 1 shows the raw material starches, processing methods, viscosity data, and evaluation results of the cooked rice improving agents 1 to 3 and the comparative agents 1 to 6. The cooked rice improving agents 1 to 3 offered favorable loosening and were confirmed to present no problem in the general evaluation of cooked rice. On the other hand, the comparative agents 1 to 5 hardly had improving effect on loosening and gave cooked rice a texture different from usual cooked rice in actual eating. Thus, the resulting cooked rice caused a feeling of strangeness. The comparative agent 6 was close to the control example and confirmed to hardly have improving effect on loosening by its addition. The commercially available cooked rice improving agent had high loosening effect and also gave cooked rice a favorable texture. However, the resulting cooked rice turned weakly brown in appearance, impairing the product value.

### Example 5

Rice cooking test was conducted according to the method of Example 4 using varying amounts of the cooked rice improving agent 1 added. As seen from the results of Table 2, cooked rice was improved in loosening even when the amount of the improving agent added was increased or decreased within the range of 0.5 to 2%.

TABLE 2

| Amount of | | | |
|---|---|---|---|
| improving | Evaluation on cooked rice | | |
| agent added | Loosening | Stickiness | Hardness |
| 0.20% | 6 | 5 | 7 |
| 0.50% | 8 | 4 | 7 |
| 2% | 8 | 3 | 7 |
| — | 3 | 6 | 6 |

### Example 6

For rice cooking test conducted according to the method of Example 4, the similar evaluation was conducted except that 0.2% of the cooked rice improving agent 1 and 0.05% each of thickeners 1 to 3 shown in Table 3 were added with respect to raw rice. The results are shown in Table 4. Improving effect on loosening based on combined use with the thickener was observed, regardless of the type of the thickener.

TABLE 3

| | Type | Product name | Company name |
|---|---|---|---|
| Thickener | Xanthan gum | NOVAXAN | ADM Far East Ltd. |
| 1 | | | |
| Thickener | Iota | SUNCARA | Taiyo Kagaku Co., |
| 2 | carrageenan | 208 | Ltd. |
| Thickener | Pectin | Classic | Dainippon Sumitomo |
| 3 | | AF70 | Pharma Co., Ltd. |
| Thickener | Ghatti gum | Ghatti Gum | San-Ei Gen F.F.I., |
| 4 | | SD | Inc . |

TABLE 4

| Combination with | | | |
|---|---|---|---|
| cooked rice | Evaluation on cooked rice | | |
| improving agent 1 | Loosening | Stickiness | Hardness |
| Thickener 1 | 8 | 6 | 7 |
| Thickener 2 | 8 | 6 | 6 |
| Thickener 3 | 8 | 7 | 6 |
| — | 6 | 5 | 7 |

### Example 7

For rice cooking test conducted according to the method of Example 4, the similar evaluation was conducted except that the amount of the cooked rice improving agent 1 added was set to 0.2% or 0.5% with respect to raw rice, and 0.000005% to 0.1% of the thickener 1 was added with respect to raw rice. As a Comparative Example, only 0.004% or 0.0004% of the thickener 1 was added with respect to raw rice and evaluated. The amount of each component added and the evaluation results are shown in Table 5. In Examples, all the samples of cooked rice were improved in loosening by virtue of effect brought about by combined use with the thickener. On the other hand, in Comparative Example, the addition of only the thickener exhibited no improvement in loosening.

TABLE 5

| Proportion of | | Ratio | | | |
|---|---|---|---|---|---|
| cooked rice | Proportion | between | | | |
| improving | of thickener | cooked rice | | | |
| agent 1 added | 1 added | improving | Evaluation on cooked rice | | |
| (with respect | (with respect | agent and | Loosen- | Sticki- | Hard- |
| to raw rice) | to raw rice) | thickener | ing | ness | ness |
| — | — | | 3 | 6 | 6 |
| 0.2% | | | 6 | 5 | 7 |
| 0.2% | 0.0004% | 500:1 | 8 | 5 | 7 |
| 0.2% | 0.004% | 50:1 | 7 | 5 | 8 |
| — | 0.0004% | | 3 | 8 | 7 |
| — | 0.004% | | 2 | 8 | 7 |
| 0.2% | 0.01% | 20:1 | 9 | 4 | 8 |
| 0.2% | 0.05% | 4:1 | 10 | 3 | 8 |
| 0.5% | 0.00005% | 10,000:1 | 9 | 6 | 7 |
| 0.5% | 0.000005% | 100,000:1 | 8 | 6 | 7 |

### Example 8

For rice cooking test conducted according to the method of Example 4, the similar evaluation was conducted except that: the amount of the cooked rice improving agent added was set to 0.5% with respect to raw rice; the amount of the thickener 1 added was set to 0.0003% with respect to raw rice; and the amount of water added for rice cooking was set to 510 g (water was added 1.7 times the amount (300 g) of raw rice) or 540 g (1.9 times the amount (300 g) of raw rice). In addition, the ratio of the weight of cooked rice to that of raw rice was calculated as an increment in weight. As a control example, an increment in weight was calculated in the same way for usual cooked rice (water was added 1.7 times the amount of raw rice) or rice cooked after addition of excessive water (1.9 times the amount of raw rice). The results are shown in Table 6. When the improving agent 1 and the thickener 1 were added, favorable cooked rice having appropriate loosening and natural stickiness was obtained, and the weight of the cooked rice was also increased.

TABLE 6

| Addition | Amount | | | | | | |
|---|---|---|---|---|---|---|---|
| of | of | | | | | | |
| improving | water | | Evaluation on cooked rice | | | | |
| agent 1 | added | Ratio of | | | | Weight | Weight |
| and | before | added | | | | after | ratio |
| thickener | rice | water to | | | | rice | to raw |
| 1 | cooking | raw rice | Loosening | Stickiness | Hardness | cooking | rice |
| Yes | 510 g | 1.7 times | 8 | 7 | 8 | 728 g | 2.43 |
| Yes | 570 g | 1.9 times | 5 | 8 | 6 | 783 g | 2.61 |
| No | 510 g | 1.7 times | 3 | 6 | 6 | 725 g | 2.42 |
| No | 570 g | 1.9 times | 1 | 10 | 2 | 777 g | 2.59 |

### Example 9

For rice cooking test conducted according to the method of Example 4, cooked rice supplemented with 0.5% of the cooked rice improving agent 1 or 2 with respect to raw rice, and cooked rice supplemented with 0.5% of the cooked rice improving agent 1 and 0.008% of the thickener 1 with respect to raw rice were left at room temperature for 24 hours after rice cooking and then subjected to sensory evaluation. The degree of aging was evaluated by comprehensively evaluating the hardness, stickiness, texture, and smell of cooked rice based on the criteria (10: the cooked rice could not be eaten without recooking/reheating [symbol] 0: the cooked rice maintained the state in which the cooked rice immediately after cooking was allowed to cool to room temperature). The results are shown in Table 7. In any case, aging-derived smell was reduced, and a dry and crumbling texture attributed to aging was very weak. This tendency was particularly marked in combined use with the thickener 1, and the resulting cooked rice maintained very favorable properties. On the other hand, the control example unsupplemented with the cooked rice improving agent could narrowly be eaten and however, was not preferable due to unique aging-derived smell perceived in usual cold rice and a dry and crumbling texture.

TABLE 7

| Cooked rice improving agent | Degree of aging |
|---|---|
| Cooked rice improving agent 1 | 3 |
| Cooked rice improving agent 1 + Thickener 1 | 1 |
| Cooked rice improving agent 2 | 2 |
| — | 6 |

### Example 10

1.2 g of salt was mixed with 160 g of each cooked rice obtained in Example 7. Rice balls were prepared using a commercially available rice ball mold. The rice ball obtained using the cooked rice containing the cooked rice improving agent had more favorable loosening and texture than those of the unsupplemented rice ball.

### Example 11

4.5 g of the cooked rice improving agent 1, 4.5 g of the cooked rice improving agent 1 and 0.045 g of the thickener 1, or 4.5 g of the cooked rice improving agent 2 was mixed with 60 mL of commercially available “Sushi Vinegar Supplemented with Kombu Dashi (Japanese soup stock made from sea tangle)” (Mizkan Group Corporation) to prepare 3 vinegar test samples. Sushi vinegar that was not mixed with the cooked rice improving agent or the thickener was also prepared as a control example. Aside from this, two 180-cc cups (300 g) of commercially available no-wash rice (KIRARA 397) were quickly washed and dipped in a sufficient amount of water at room temperature for 30 minutes. Water was removed from the obtained rice using a colander. The total weight was brought to 810 g, and automatic rice cooking was performed using a domestic electric rice cooker. Each vinegar test sample was sprinkled over the obtained cooked rice, which was then mixed with air using a rice paddle so that the vinegar test sample was uniformly spread and heat was released. The rice was covered with plastic wrap to prevent water evaporation and cooled to room temperature. Then, 28 g each of sushi rice balls was formed using a commercially available sushi rice ball mold for sushi rice. The obtained sushi rice balls were evaluated for loosening (Table 8). All the samples formulated with the improving agent of the present invention exhibited favorable loosening, demonstrating improving effect on sushi rice.

TABLE 8

| Cooked rice improving agent | Loosening |
|---|---|
| Cooked rice improving agent 1 | 6 |
| Cooked rice improving agent 1 + Thickener 1 | 7 |
| Cooked rice improving agent 2 | 7 |
| — | 3 |

### Example 12

Commercially available rice was quickly washed. 4 control samples supplemented with water 1.0 to 1.6 times the weight of raw rice, and 6 samples obtained by adding thereto 3 to 10% of the cooked rice improving agent 1 with respect to raw rice were separately prepared, enclosed in pouches, and then subjected to retort treatment under conditions involving 120° C. and 30 minutes. The obtained retort products were taken out of the pouches, and hot water was poured therein just enough to cover to prepare Yuzuke (boiled rice with hot water poured over it), which was then evaluated for loosening properties and the texture of rice grains. The texture of grains was evaluated by ten-titer sensory testing. The larger numeric values represent that the rice grains were more highly kept in shape. The results are shown in Table 9. All the samples formulated with the improving agent of the present invention exhibited favorable loosening properties and also maintained the texture of rice grains required for chazuke or the like. Specifically, it was confirmed that the present invention exceedingly facilitates the application of retort cooked rice to chazuke or zosui.

TABLE 9

| Proportion of | | | | |
|---|---|---|---|---|
| cooked rice | Ratio of | | | |
| improving | added | | | |
| agent 1 added | water | Evaluation of Yuzuke | | |
| (with respect | to raw | | Texture | |
| to raw rice) | rice | Loosening | of grains | General evaluation |
| — | 1.0 | 1 | — | Cooked rice became |
| | times | | | a rice cake-like |
| — | 1.2 | 1 | — | plate form and |
| | times | | | thus, could not be |
| | | | | evaluated. |
| — | 1.4 | 1 | — | |
| | times | | | |
| — | 1.6 | 2 | 1 | Cooked rice was |
| | times | | | slightly loosened, |
| | | | | but had no texture |
| | | | | of grains. |
| 5% | 1.0 | 8 | 8 | Cooked rice could |
| | times | | | narrowly be eaten, |
| | | | | but had a hard |
| | | | | texture. |
| 5% | 1.2 | 8 | 6 | No problem as |
| | times | | | Yuzuke of cold |
| | | | | rice. |
| 5% | 1.4 | 8 | 5 | No problem as |
| | times | | | Yuzuke of cold |
| | | | | rice. |
| 5% | 1.6 | 7 | 5 | Cooked rice could |
| | times | | | narrowly be eaten, |
| | | | | but had too much |
| | | | | glutinous texture. |
| 3% | 1.4 | 5 | 4 | No problem as |
| | times | | | Yuzuke of cold |
| | | | | rice. |
| 10% | 1.4 | 8 | 6 | No problem as |
| | times | | | Yuzuke of cold |
| | | | | rice. |

### Example 13

The pouches of the products obtained in Example 12 by subjecting a sample (ratio of added water: 1.4 times the weight of raw rice) to retort treatment were opened, and the products were heated using a microwave and tasted. As a result, a control product free from the cooked rice improving agent was in a rice cake-like plate form and thus, could not be eaten as cooked rice, whereas all the products supplemented with 3%, 5%, or 10% of the cooked rice improving agent exhibited favorable loosening properties and also maintained the texture of rice grains.

### INDUSTRIAL APPLICABILITY

The present invention provides a quality improving agent for cooked rice which effectively imparts improving effect on loosening properties, anti-aging property, and/or water retentivity to cooked rice with as little influence as possible on the original texture and taste of the cooked rice, a method for producing cooked rice using the quality improving agent, and a cooked rice with improved loosening properties, anti-aging property, and/or water retentivity using the method for producing cooked rice.

1. A method for producing cooked rice with improved loosening properties, anti-aging property, and/or water retentivity, comprising adding and mixing a quality improving agent which is a degradation product of substituted modified starch with a viscosity of 15 mPa·s or higher at 30% by mass in an aqueous solution and 3000 mPa·s or lower at 10% by mass in an aqueous solution, wherein the degradation product of substituted modified starch is a degradation product obtained by using, as a base material, one or more substituted modified starches selected from the group consisting of hydroxypropyl starch, hydroxypropylated distarch phosphate, and starch sodium octenylsuccinate, and wherein the degradation product of substituted modified starch is prepared by subjecting substituted modified starch to hydrolysis treatment with an enzyme in the process of rice cooking for preparing cooked rice.

2. The method for producing cooked rice according to claim 1, wherein the quality improving agent further comprises a thickener in addition to the degradation product of substituted modified starch.

3. The method for producing cooked rice according to claim 2, wherein the thickener is one or more thickening polysaccharides selected from the group consisting of xanthan gum, guar gum, ghatti gum, and carrageenan.

4. The method for producing cooked rice according to claim 1, wherein the quality improving agent for cooked rice is mixed with raw rice in an amount of 0.1 to 10% by weight with respect to raw rice and cooked in the process of rice cooking for preparing cooked rice.

5. The method for producing cooked rice according to claim 1, wherein the quality improving agent for cooked rice is mixed with white cooked rice in an amount of 0.1 to 10% by weight with respect to white cooked rice in the process of rice cooking for preparing cooked rice.

6. The method for producing cooked rice according to claim 1, wherein the cooked rice is white rice, salted rice, or sushi rice.

7. Cooked rice with improved loosening properties, anti-aging property, and/or water retentivity, produced with a method for producing cooked rice according to claim 1.

8. The cooked rice according to claim 7, wherein the cooked rice is retort-sterilized.
